(19) United States
(12) Patent Application Publication
(10) Pub. No.: US 2025/0117109 A1
(43) Pub. Date: Apr. 10, 2025

(54) Portable Display, System, and Method

(71) Applicant: Nihal Advani, Chicago, IL (US)

(72) Inventor: Nihal Advani, Chicago, IL (US)

(21) Appl. No.: 18/910,270

(22) Filed: Oct. 9, 2024

Related U.S. Application Data
(60) Provisional application No. 63/598,028, filed on Nov. 10, 2023.
(60) Provisional application No. 63/543,283, filed on Oct. 9, 2023.

(51) Int. Cl. G06F 3/0482; G06F 3/0484; G06F 3/14; G06F 40/109

(52) U.S. Cl. CPC G06F 3/0482; G06F 3/0484; G06F 3/14; G06F 40/109

(57) ABSTRACT

Methods, systems, and apparatus, including computer programs encoded on computer storage media, for displaying content on a portable display. One of the systems includes a portable electronic display for displaying a personalized message and that includes a first communication module; and a host system that includes a second communication module and is in wireless communication with the portable electronic display and with one or more requesting mobile devices, the host system being programmed to receive a message request from one of the one or more requesting mobile devices, present the message request for approval, upon approval and activation, send, using the second communication module and to the first communication module, the personalized message to the portable display for display.

### CROSS-REFERENCE TO RELATED APPLICATION

This application claims the benefit of U.S. Provisional Application No. 63/598,028, filed Nov. 10, 2023, and U.S. Provisional Application No. 63/543,283, filed Oct. 9, 2023, the contents of which are incorporated by reference herein.

### BACKGROUND

Databases include records for various entities. For instance, a database can include records that indicate accounts and permissions for those accounts.

In some situations, an entity can request presentation of content on a sign, e.g., at a venue. The content can draw attention to a particular patron or group of patrons at the venue. The sign can be any appropriate type of sign, such as a marquee sign in which the message is formed by manually placing letters in order or an electronic display.

### SUMMARY

In general, one aspect of the subject matter described in this specification can be embodied in a system that includes a portable electronic display for displaying a personalized message and that includes a first communication module; and a host system that includes a second communication module and is in wireless communication with the portable electronic display and with one or more requesting mobile devices, the host system being programmed to receive a message request from one of the one or more requesting mobile devices, present the message request for approval, upon approval and activation, send, using the second communication module and to the first communication module, the personalized message to the portable display for display and charge an account accessed on the patron mobile device for the display of the personalized message.

In general, one aspect of the subject matter described in this specification can be embodied in a system that includes a portable electronic display for displaying a personalized message and that includes a first communication module; and a host system that includes a second communication module and is in wireless communication with the portable electronic display and with one or more requesting mobile devices, the host system being programmed to receive a message request from one of the one or more requesting mobile devices, present the message request for approval, upon approval and activation, send, using the second communication module and to the first communication module, the personalized message to the portable display for display.

In general, one aspect of the subject matter described in this specification can be embodied in methods that include the actions of receiving, at a host system, a request for presentation of content on a portable display and that identifies a) a personalized message and b) at least one image; creating, in a database of the host system, a record i) for the request and ii) that identifies the personalized message, the at least one image, and a status with an initial status value; providing, by the host system and to a device for an administrative account, an approval request that includes the personalized message, the at least one image, and a user interface element that initiates approval or rejection of the request; receiving, by the host system and from the device, data that indicates a selection of the user interface element approving or rejecting the request; and in response to determining that the data indicates the selection of the user interface element approval the request: updating, in the database, the status of the record to have an approved status value; and transmitting, by the host system and using at least a wireless communication mode, an instruction to a portable display to cause the portable display to display at least a portion of the personalized message and the at least one image.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, the method can include, in response to updating the status of the record to have the approved status value, transmitting, to a second device for a second administrative account, an instruction to cause the second device to display a user interface with a first identifier for the request and a presentation initiation user interface element; receiving, by the host system and from the second device, second data that indicates a selection of the presentation initiation user interface element. Transmitting, by the host system and using at least the wireless communication mode, the instruction to the portable display to cause the portable display to display at least the portion of the personalized message and the at least one image can be responsive to receiving the second data that indicates a selection of the presentation initiation user interface element.

In some implementations, the administrative account and the second administrative account can have different account permissions.

In some implementations, the method can include selecting, from a plurality of portable displays and using an identifier for the record that was included in the request, the portable display.

In some implementations, receiving the request can include receiving, by the host system and from a requesting device, the request.

In some implementations, selecting the portable display from the plurality of portable displays can use a physical location for the requesting device that is indicated in the record.

In some implementations, selecting the portable display might occur without using an identifier for the requesting device or an account for the requesting device.

In some implementations, the method can include selecting, from a plurality of portable displays, two or more portable displays including the portable display. Transmitting the instruction can include transmitting, by the host system and using at least the wireless network and to each of the two or more portable displays, a corresponding instruction to cause the corresponding portable display to display a respective portion of the personalized message.

In some implementations, receiving the request can include receiving the request that indicates a font size, a font color, and one or more font effects for the personalized message. Creating the record can include creating the record that includes, in corresponding fields for the record, data identifying the font size, the font color, and the one or more font effects.

In some implementations, the at least one image can be part of a video sequence.

In some implementations, the at least one image can be a dynamic image.

In some implementations, the request can include the at least one image.

In some implementations, the request can include an identifier for the at least one image already stored on the host system.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. In some implementations, the systems and methods described in this specification can reduce resource usage, e.g., computational resources usage, compared to other systems. For instance, by receiving a request that identifies a presentation and transmitting an instruction to a portable display to cause the portable display to display at least a portion of the presentation, e.g., a personalized message and the at least one image, the systems and methods can reduce computational resource usage compared to other systems.

In some implementations, the systems and methods described in this specification can create an enhanced venue experience, e.g., by providing more detailed presentations such as personalized messages, more options for presentations, more interactive presentations, or a combination of these. The enhanced venue experience can enable a person to better celebrate an occasions, e.g., a birthday or anniversary, further enjoy a prior type of experience at the venue, or a combination of both, e.g., through personalized digital signs, content, experiences, or a combination of these, that better celebrate the moment. In some implementations, the systems and methods described in this application can create a new type of data record compared to other systems, e.g., that includes values for a personalized message, at least one image, a physical location identifier for a requesting device, a request status, a font size, a font color, one or more font effects, or a combination of these.

In some implementations, the systems and methods described in this specification can increase revenue for an entity, e.g., by creating a new revenue stream using the presentations. The entity can be the venue at which the presentation is displayed, given revenue from the presentation, increased sales of other products, interactive sponsored experiences, or a combination of these. The entity can be a brand, e.g., that leverages the portable display for sponsored experiences that are highly interactive and engaging, increasing brand awareness and loyalty. The entity can be a DJ, artist, content creator, musician, or another appropriate type of celebrity who generate additional revenue through people ordering presentations with their content, service, experience, or a combination of these.

In some implementations, the systems and methods described in this specification can increase efficiency, e.g., computational efficiency, by allowing the people to directly order personalized presentations, e.g., personalized messages or other types of presentations, without needing venue staff, or systems, as part of the presentation request process, e.g., without needing venue staff to manually put together letters for a marquee sign.

### BRIEF DESCRIPTION OF THE DRAWINGS

FIG. 1 is a schematic diagram of an example environment that includes a host system and a portable display.

FIGS. 2A-B depict views of an example of a portable display.

FIGS. 3A-C depict views of a portable display with a frame.

FIGS. 4A-Q are example user interfaces that depict user interface elements for an end user flow on a requesting mobile device.

FIGS. 5A-5I are example user interfaces and for a venue and an example presentation display by a portable display.

FIG. 6 is a flow diagram of an example process for transmitting an instruction to a portable display.

FIG. 7 is a block diagram of computing devices that may be used to implement the systems and methods described in this specification.

Like reference numbers and designations in the various drawings indicate like elements.

### DETAILED DESCRIPTION

Some systems include displays that can present content. However, these systems generally do not enable presentation of advanced features, e.g., and might only present basic text.

To provide for advanced presentation features, a host system can communicate with a portable display for displaying a personalized message. The host system can maintain a database of records each of which is for a corresponding personalized message. The database can include one or more new fields for the personalized message, such as fields for the personalized message, at least one image, a physical location identifier for a requesting device, a request status, a font size, a font color, one or more font effects, or a combination of two or more of these.

The host system can then use the new fields when generating a user interface for presentation. For instance, the host system can generate a background for the user interface using data for the at least one image. The host system can use values for other fields to generate content for presentation on top of the background.

In some examples, the host system can select one or more portable displays for presentation of the personalized message. For example, when a venue has multiple portable displays, the host system can select one or more of the multiple portable displays for presentation of the personalized message. The host system can use a physical location for a requesting device, e.g., a physical location at a venue, to select the one or more portable displays. In some examples, the host system can use a physical location of a portable display, a functional capability of a portable display, or a combination of both, to select the one or more portable displays.

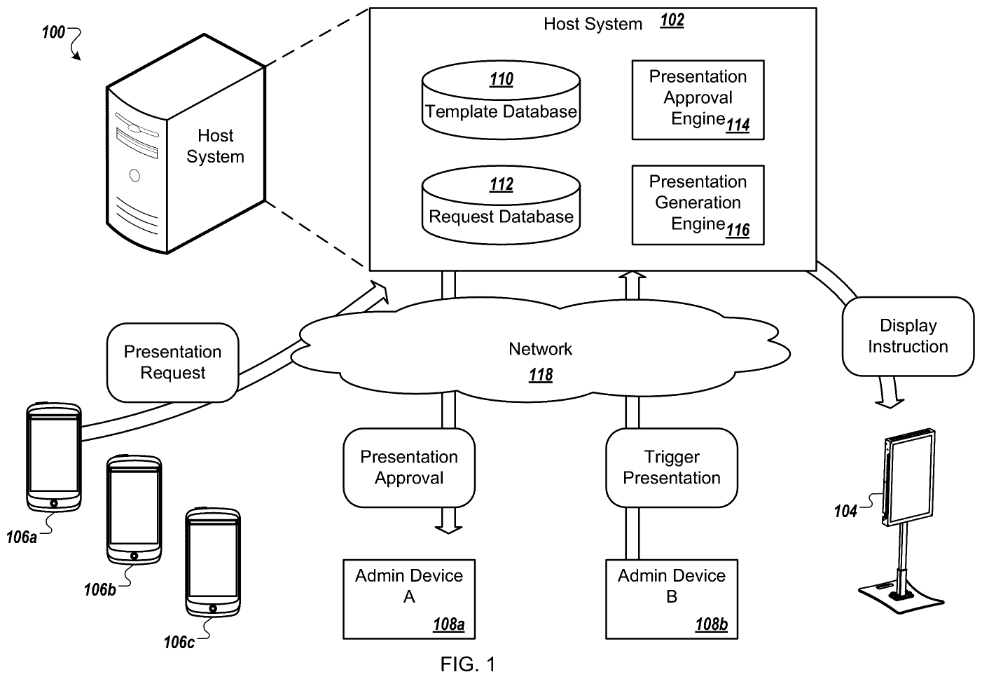

FIG. 1 is a schematic diagram of an example environment 100 that includes a host system 102 and a portable display 104. The host system 102 can transmit instructions to the portable display 104 given receipt of a presentation request from one of multiple requesting devices 106a-c. For instance, the host system 102 can receive requests for message display from the requesting devices 106a-c. The received requests can be presented for approval by the host system 102, e.g., on an administrative device A 108a. The host system 102 can approve or reject the request. Approved requests are queued on the host system 102 and sent to the portable display 104 at the appropriate time, e.g., in response to receipt of a trigger from the administrative device B 108b.

The host system 102 maintains a template database 110 of template data for presentation requests. The template data can include template images. The template images can be used for a background of a user interface generated by a presentation generation engine 116. The images can be still images, e.g., that do not change. The images can be dynamic images, e.g., gifs or images in a video sequence. The template data can include one or more animations. For instance, the template data can include data for presentation of a confetti animation or a dry ice animation as part of a personalized message.

A first requesting device 106a can present a user interface, e.g., on a display included in the first requesting device 106a. For instance, the first requesting device 106a can be a mobile device such as a smartphone that includes an integrated display. The user interface can be any appropriate type of user interface, such as an interface for a web page or a native application interface.

The first requesting device 106a can present the user interface in response to any appropriate type of trigger. Some examples of triggers can include capture of a QR code that includes an identifier for the user interface, e.g., that identifies a URL for the web page, or navigation to the web page in a browser.

The user interface, some examples of which are described in more detail below, can include any appropriate type of content for a personalized message. For instance, the user interface can include one or more user interface elements for selection of some of the template data from the template database 110. The user interface elements can be presented with content for the corresponding templates. For instance, a user interface element for a background element can include a text label, a thumbnail image, or both, for the background element.

The first requesting device 106a receives, through the user interface, input indicating one or more parameters for the personalized message. The input can be any appropriate type of input, such as speech input, text input, or a combination of both.

The first requesting device 106a can receive input indicating a request to create content, upload content, or a combination of both. For instance, the first requesting device 106a can receive input that creates content, e.g., on top of template data, from scratch, or a combination of both. The first requesting device 106a can capture one or more images, e.g., still images or part of a video sequence, and upload the captured images to the host system 102.

The first requesting device 106a can transmit a presentation request for the personalized message. For example, in response to receipt of input to submit the request, the first requesting device 106a can transmit the presentation request to the host system 102. The first requesting device 106a can use any appropriate type of network to transmit the presentation request, such as a wide area network (“WAN”), a local area network (“LAN”), the Internet, or a combination of these. For example, the first requesting device 106a can transmit the presentation request via a Wi-Fi network or over a mobile network.

When the host system 102 and the first requesting device 106a are both at the same physical location, e.g., a venue, the first requesting device 106a can communicate with the host system 102 using a LAN for the physical location. In these examples, the presentation request can include location data, e.g., for a wireless router with which the first requesting device 106a is connected, for an area at the physical location at which the first requesting device 106a is located, such as a table, or a combination of both. The first requesting device 106a, the wireless router, or a combination of both, can include the location data in the presentation request. When the presentation request is encrypted, e.g., to increase security, privacy, or both, the first requesting device 106a includes the location data in the presentation request. In some examples, the wireless router can add an identifier for the wireless router to an encrypted presentation request.

The host system 102 receives the presentation request and generates a record in a request database 112 for the presentation request. The host system 102 can analyze the presentation request to determine a request type for the record. In some examples, different request types can have different fields. Some fields can be included in records for all request types. For instance, the host system 102 can determine whether the presentation request identifies a template or uploaded content for a background. The uploaded content can include an image, e.g., a static or dynamic image. When the host system 102 determines that the presentation request identifies a template, the host system 102 can generate a record that includes a background field with an identifier that links the record to corresponding data in the template database 110. When the host system 102 determines that the presentation request identifies uploaded content, the host system 102 can generate a record that includes a binary large object, e.g., “BLOB”, field for the uploaded content, or a background field with an identifier to another database in which the BLOB is stored.

The host system 102 can provide a presentation approval request to the administrator device A 108a. For instance, the host system 102 can receive, from the administrative device A 108a, a request for a user interface that includes information about one or more presentation requests. In some examples, the user interface includes information only about presentation requests for one venue. In response to receipt of the request for the user interface, the host system 102, e.g., a presentation approval engine 114, can provide the presentation approval request to the administrative device A 108a.

The user interface can be any appropriate type of user interface. For instance, the user interface can be a native application interface or a web page interface. In contrast to the user interface presented on the requesting device, which might be presented fewer than a threshold quantity of times, the administrative user interface will likely be presented at least the threshold quantity of times. As a result, the administrative user interface can be a native application user interface to provide reduced latency compared to a web page interface.

As described in more detail below, the administrative device A 108a can approve or reject the presentation request. For instance, the administrative device A 108a can present the user interface that depicts information for one or more presentation requests including the presentation request transmitted by the first requesting device 106a. The user interface can include, for each request, an approval user interface element that, upon selection, initiates approval of the corresponding presentation request. In response to the presentation, the administrative device A 108a can receive input that indicates approval or rejection of the presentation request. The administrative device A 108a can transmit, to the host system 102, a message that indicates the corresponding approval or rejection of the presentation request.

The host system 102, e.g., the presentation approval engine 114, in response to receipt of a message that indicates approval of the presentation request, can perform one or more actions for the approval of the presentation request. For instance, the presentation approval engine 114 can update a status of a record in the request database 112 to indicate that the status should be changed from an initial value, e.g., requested, to an approved value. The status can have multiple appropriate values, such as requested, approved, e.g., in progress, rejected, or completed.

The presentation approval engine 114, or another component of the host system 102, can transmit a trigger presentation message to an administrative device B 108b. After receipt of the trigger presentation message, the administrative device B 108b can present a user interface that depicts information about the presentation request and a trigger presentation user interface element to initiate presentation of the personalized message on the portable display 104. The information about the presentation request can include the area of the venue to which the portable display 104 should be brought, e.g., while presenting at least a portion of the personalized message.

The administrative devices A-B 108a-b can be the same device or different devices. For instance, when a single device both approves and triggers a presentation request, e.g., a single user, the administrative devices A-B 108a-b are the same device. In these examples, the administrative device A 108a can still send the presentation approval to the host system 102. The host system 102 need not transmit the presentation trigger to the administrative device A 108a. Instead, upon approval of the presentation request, the administrative device A 108a can remove the approval user interface element and present the trigger presentation user interface element for the presentation request.

The administrative device B 108b can transmit the trigger presentation message to the host system 102 at any appropriate time. For instance, when a drink order is being filled and ready for delivery to a table at the venue for which the personalized message was requested, the administrative device B 108b can receive input indicating activation by staff at the venue, e.g. a server, of the trigger presentation user interface element. In response to receipt of the input activating the trigger presentation user interface element, the administrative device B 108b can transmit the trigger presentation message to the host system 102.

A presentation generation engine 116 can generate one or more instructions for presentation of a personalized message on the portable display 104. The instructions can be any appropriate type of instructions. For example, the presentation generation engine 116 can generate the one or more instructions for a native application executing on the portable display 104 or a virtual application for the portable display 104. The native application can be a web browser or any other appropriate type of application, e.g., an application specific to the host system 102.

The instructions can include any appropriate type of content. For instance, the instructions can include data representing the personalized message, e.g., received from the first requesting device 106a and included in the presentation request. In some examples, the instructions can include data representing one or more user interface elements for the user interface that will be presented on the portable display 104. The user interface elements can include a background for the user interface. In some examples, the instructions can identify one or more user interface elements stored on the portable display 104 or another system other than the host system 102. As a result, the presentation generation engine 116 can reduce network usage by identifying components stored on the portable display 104 or the other system that is closer, considering network connection latency and usage, to the portable display than the host system 102.

In some implementations, the presentation generating engine 116 can select a user interface layout from multiple layouts using data for the presentation request. For instance, a first type of personalized message can have a first layout and a second type of personalized message can have a second, different layout. The presentation generation engine 116 can then select the appropriate layout for the presentation request using the type of the personalized message.

In some examples, the presentation generation engine 116 can select the user interface layout using other data for the request, such as a number of elements for presentation, a type of elements for presentation, or a presentation type, the latter of which is described in more detail below. Briefly, some presentation types can include a personalized message, a leader board, an interactive experience, a personalized greeting, an auction message, or a branded experience. The request database 112 can have different data objects, with different fields, for at least some, if not all, of the different presentation types.

The presentation generation engine 116 can transmit the one or more instructions to the portable display 104 to cause the portable display 104 to display the personalized message. For example, the portable display 104 can receive the one or more instructions and provide the one or more instructions as input to an application. The application can use the instructions to present a user interface that includes the personalized message.

Although FIG. 1 depicts the portable display 104 as including a screen, other implementations are possible. For instance, the portable display 104 can generate a holograph that displays the personalized message, or another presentation type, such as those described in more detail below.

The host system 102 can include a communication module for wired, wireless, or both, communication with the portable display 104, the requesting devices 106a-c, or both. The communication module can enable communication with the portable display 104 via Wi-Fi or Bluetooth, for example. In some examples, the communication module is an Ethernet communication module that communicates with one or more devices at the venue, e.g., a wireless router, that enable wireless communication with the portable display 104.

The portable display 104 can include a communication module, e.g., a wireless communication module. The communication module can be a USB adapter that couples with the portable display 104 and provides wireless communication for the portable display 104.

In some implementations, the portable display 104 can include a frame, discussed in more detail below. The frame can be an integrated component of the portable display 104, a separate component that couples to the portable display, or a combination of both. When the frame includes one or more configurable elements, the one or more instructions can include at least one instruction for the one or more configurable elements. For instance, the configurable elements can include a light, a smoke dispenser, a sparkler, a laser, or a confetti dispenser. The instructions can cause the light, sparkler, laser, or a combination of these, to turn on, the confetti dispenser to dispense confetti, the smoke dispenser to dispense smoke, or a combination of two or more of these.

The confetti dispenser can include an aperture that receives confetti and a mechanical component that dispenses the confetti. The mechanical component can include a door to allow the confetti to fall out of the frame, e.g., out of the bottom, side, or top of the frame. The mechanical component can include an arm or another moveable component to move the confetti out of the aperture, e.g., when the aperture is on the side or top of the frame. When the aperture is on the side or top of the frame, the mechanical component can cause the confetti to appear to burst out of the aperture.

The smoke dispenser can include one or more components that enable the frame to dispense smoke, e.g., using dry ice or the like. For instance, the smoke dispenser can include an aperture that holds the dry ice and an opening that permits the smoke to emit from the aperture, e.g., while maintaining the dry ice in the aperture. The smoke dispenser can include a shutter that holds the dry ice, or confetti, in place in the aperture. The smoke dispenser can include a motor that moves the shutter, e.g., to create the opening through which the smoke, confetti, or both, pass.

The environment 100 can include more than one, e.g., multiple, portable displays 104. The multiple portable displays 104 can be for a single venue. For example, each of the multiple portable displays 104 can be for an area within the single venue. The areas can be separate areas, overlapping areas, duplicate areas, e.g., two portable displays for the same area, or a combination of these.

The presentation generation engine 116 can select one or more portable displays for a personalized message. The presentation generation engine 116 can use a physical location of the requesting device 106a-c, e.g., a table, a request type, a presentation type, a size for a request, a type of user interface elements, or a combination of these. The request type, as indicated above, can be selection of data from the template database 110 or uploaded content. The size for the request can include an amount of content to display for the request, e.g., a number of characters, a quantity of user interface elements, or a combination of these. The type and quantity of user interface elements are described in more detail below.

In some examples, by having multiple portable displays, the host system 102 can satisfy multiple presentation requests substantially concurrently. For instance, the host system 102 can satisfy a request from the first requesting device 106a and the second requesting device 106b concurrently, at least in part.

Although the environment 100 is described with reference to multiple, e.g., three, requesting devices, the environment 100 might include a single requesting device 106a-c at any particular time. In this way, the host system 102 can satisfy a single presentation request during some time periods, while being configured to satisfy multiple presentation requests during other time periods.

The host system 102 can include a request queue. The request queue, e.g., a data structure that represents the pending requests, can include data that identifies the corresponding requests and the location of the requests in the queue. The host system 102 can process the requests in the queue in order, e.g., FIFO or LIFO. Using the request queue, the host system 102 can determine for which requests to send a presentation approval message, to send instructions to a corresponding portable display 104, or a combination of both.

In some examples, the host system 102 can include multiple queues. The multiple queues can be for different request status, different portable displays, or a combination of both. For instance, the host system 102 can include a queue for each of two or more request statuses, e.g., requested, in progress, rejected, or completed. In some examples, the host system 102 can include a first queue for requested presentation requests and a second queue for in progress presentation requests. The host system 102 can have one or more queues for each portable display 104 when the environment 100 includes multiple portable displays.

In some implementations, a presentation request can be identified in multiple queues. For instance, when presentation of a personalized message or another type of presentation, should be displayed using multiple portable displays, then the corresponding presentation request can be in a queue for each of the multiple portable displays that will be used to display the presentation.

The host system 102 can include a presentation routing engine. The presentation routing engine can determine whether there might be a conflict with display of two presentations. If so, the presentation routing engine can determine whether to perform one or more corrective actions. For example, the presentation routing engine can determine that the host system previously received a presentation trigger message and sent instructions to a first portable display. The presentation routing engine can determine that the host system just received a second presentation trigger message for a presentation currently assigned to the first portable display. Since the first portable display is currently in use, the presentation routing engine can determine whether another portable display is available for display of the presentation. The presentation routing engine can provide a prompt to the device from which the trigger was received for an identifier of a portable display to which the corresponding presentation should be sent. The presentation routing engine can access a list of portable displays and determine whether another portable display is not currently in use, e.g., has an available status. In some examples, the presentation routing engine can determine whether the other portable display has a location that satisfies a location criterion, e.g., satisfies a distance threshold from the area in which the requesting device is located. When the presentation routing engine determines that another portable display is available for use, the presentation routing engine can update data, e.g., in the request database 112, one or more queues, or a combination of both, to indicate that the other portable display will display the presentation.

When the presentation routing engine determines that another portable display is not available for display of the presentation, the presentation routing engine can determine to not update a portable display assignment for the presentation. The presentation routing engine can send a message to the administrative device from which the presentation trigger was received to indicate that a portable display is not available.

In some implementations, the host system 102 manages presentation requests for multiple venues. In these implementations, the request database 112 would include data that indicates a corresponding venue to which the request applies. For instance, the request database 112 can include separate tables for different venues, a field in a single database that indicates venue, or other appropriate data to differentiate requests for the different venues. Similarly, the host system 102 can maintain data for different displays at the different venues so as to select a portable display for a corresponding venue upon receipt of a presentation trigger message.

In some implementations, the host system 102 can communicate with one or more automated devices at a corresponding venue. The automated devices can include robots, e.g., drones, that are part of an experience. For instance, the host system 102 can provide a drone with an instruction to dispense confetti during provision of a corresponding portable display 104. In these examples, the drone can dispense confetti in addition to, or instead of, confetti provided by a frame of the portable display. A drone can provide one or more other features similar to the features described for the frame. The drone, the portable display 104, or both, can provide experiences for other senses in addition to sight and sound, e.g., scent, touch, taste, or a combination of these. For instance, the portable device can dispense, for touch experience, a spray, an aerosol, e.g., with gas or a liquid such as water, provide haptic feedback, or a combination of these. In some examples, a robot, e.g., a ground based robot or a drone, can move the portable display 104, e.g., the display can be incorporated into or attached to the robot.

The environment 100 can include other devices to present the personalized message or another type of presentation. For instance, the environment can include a robot, e.g., a drone, a holograph generation device, a digital table, a digital case, e.g., for a bottle or can, a digital ice bucket, or a combination of two or more of these. One or more of the components can be interactive.

The host system 102 is an example of a system implemented as computer programs on one or more computers in one or more locations, in which the systems, components, and techniques described in this specification are implemented. The administrative devices A-B 108a-b can include personal computers, mobile communication devices, and other devices that can send and receive data over a network 118. The network 118, such as a local area network (“LAN”), wide area network (“WAN”), the Internet, or a combination thereof, connects the host system 102, the portable display 104, the requesting devices 106a-c, and the administrative devices A-B 108a-b. In some examples, the host system 102 can have a direct connection with a device, e.g., the requesting devices 106a-c, the administrative devices 108a-b, the portable display 104, or a combination of two or more of these. The host system 102 can use a single computer or multiple computers operating in conjunction with one another, including, for example, a set of remote computers deployed as a cloud computing service.

The host system 102 can include several different functional components, including the presentation approval engine 114, the presentation generation engine 116, and the presentation routing engine. The presentation approval engine 114, the presentation generation engine 116, or a combination of these, can include one or more data processing apparatuses, can be implemented in code, or a combination of both. For instance, each of the presentation approval engine 114, and the presentation generation engine 116 can include one or more data processors and instructions that cause the one or more data processors to perform the operations discussed herein.

The various functional components of the host system 102 can be installed on one or more computers as separate functional components or as different modules of a same functional component. For example, the presentation approval engine 114, and the presentation generation engine 116 of the host system 102 can be implemented as computer programs installed on one or more computers in one or more locations that are coupled to each through a network. In cloud-based systems for example, these components can be implemented by individual computing nodes of a distributed computing system.

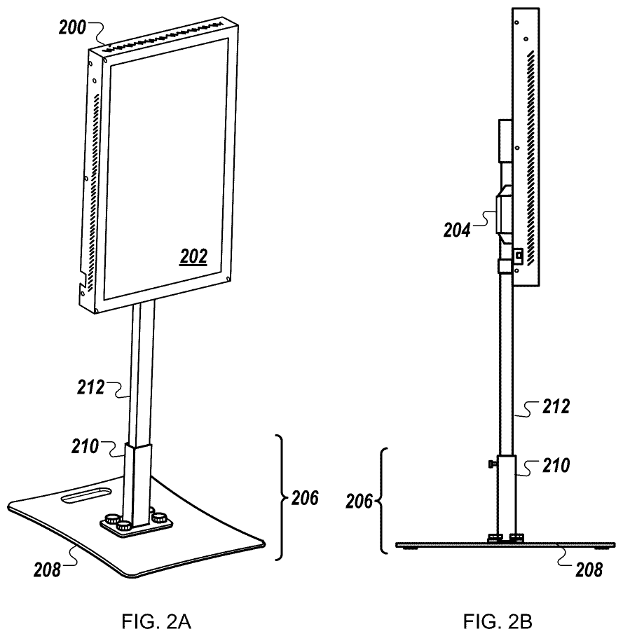

FIGS. 2A-B depict views of an example of a portable display 200. FIG. 2A is a perspective view of an example of the portable display 200, e.g., for use in the environment 100 shown in FIG. 1. The display is a full color, high-definition display capable of displaying video images on a screen 202. The video images can include a single image or a sequence of images, e.g., a video.

The portable display 200 includes a power source (not shown), such as a battery, allowing the portable display 200 to be moved around during use without being encumbered by a power cable. The battery can be any appropriate type of battery.

The portable display 200 can be any appropriate size and weight such that it is portable and visible at the appropriate distances for use (e.g., messages can be viewed at distances from 5 feet to about 20 feet). In some implementations, the portable display 200 has a diagonal dimension of 20 inches or more (e.g., 25 inches or more, 30 inches or more, 35 inches or more, 35 inches or more, 40 inches or more, 45 inches or more, 50 inches or more, 55 inches or more, 60 inches or more, such as 100 inches or less, 90 inches or less, 80 inches or less, 70 inches or less, 60 inches or less). The portable display 200 can weigh 1 kg to 20 kg (e.g., 10 kg or less, 8 kg or less, 6 kg or less, 5 kg or less, such as 2 kg or more, 3 kg or more, 4 kg or more).

The portable display 200 includes one or more, e.g., two, handles 204 on the back surface facilitating carrying the portable display 200, as depicted in FIG. 2B. FIG. 2B is a side view of the portable display shown in FIG. 2A. In FIG. 2B, only a single handle 204 is depicted, e.g., on the right-hand side of the back surface. In implementations that include two or more handles, the portable display 200 can include additional handles on the left-hand side, the bottom, the top, or a combination of these. The handles 204 can extend away from the portable display 200 in any appropriate direction. For instance, the handles 204 can extend perpendicular from the back surface of the portable display 200. In some examples, the handles 204 can lie on substantially the same plane as the portable display 200, e.g., outward from the side edges of the portable display 200. The handles 204 can extend from the portable display 200 in other appropriate directions.

The portable display 200 includes an optional stand 206. The stand 206 includes a base 208 and a connector 210. An optional pole 212, attached to the display 200, can mate with the connector 210 on the stand 206. The connector 210 can enable display 200 placement in and removal from the stand 206. The stand 206 can support the display 200 while the display is not in use while allowing the display 200 to be removed, e.g., easily, from the stand 206 for use. The use can include carrying by an entity, e.g., a person or a robot, during display of a presentation.

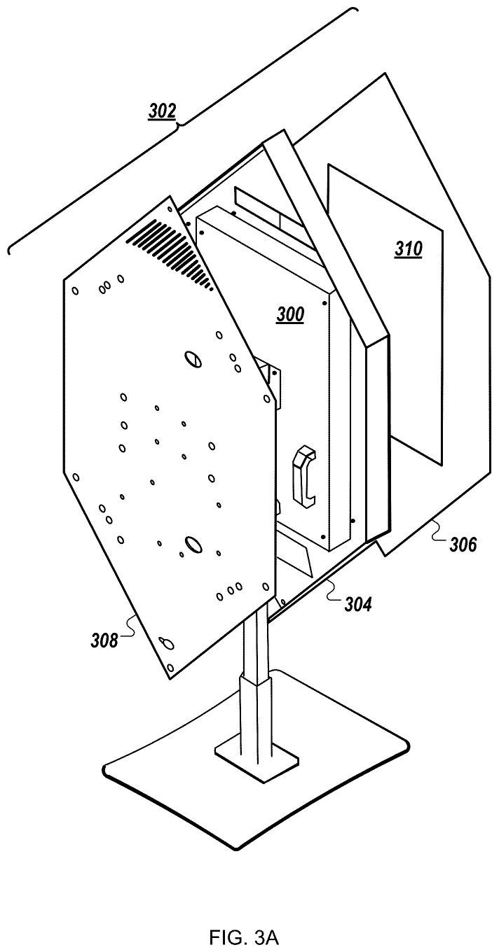

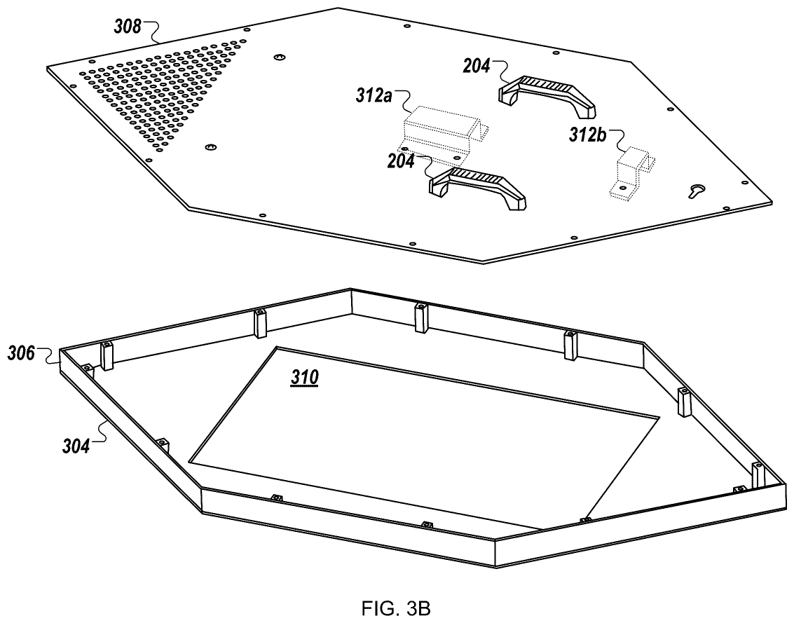

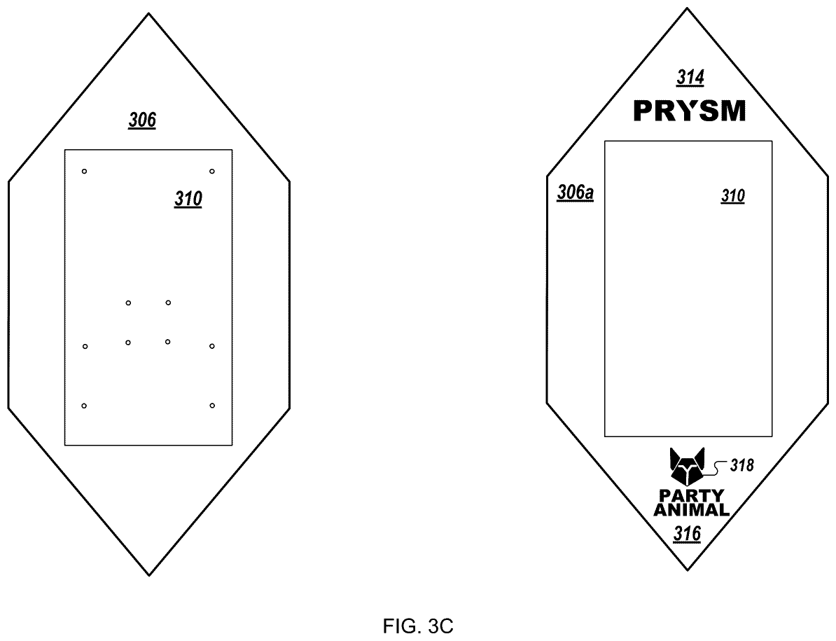

FIGS. 3A-C depict vies of a portable display 300 with a frame 302. FIGS. 3A-B depict perspective views of the frame 302. FIG. 3C depicts a plan view of the frame 302. The portable display 300 can be the portable display 200 shown in FIGS. 2A-B.

The frame 302 includes a box 304 which accommodates the display 300. The box 304 includes a front panel 306 and a back panel 308. In some examples, one or both of the front panel 306 and the back panel 308 are separate components of the frame 302.

The portable display 300 couples, e.g., attaches, to the frame 302 using any appropriate components. For instance, the portable display 300 can couple to the frame 302 using one or more screws, one or more nuts, glue, e.g., epoxy, or a combination of these.

The frame 302 enables use of the handles 204 of the portable display 300. For instance, the back panel 308 can include apertures (not shown) that enable passage of the handles 204 through the back panel 308. In some examples, as shown in FIG. 3B, the back panel 308 includes one or more apertures that enable the handles to be attached to the outside surface, opposite a surface of the back panel 308 nearest the portable display 300. In these examples, the apertures can allow screws that pass through openings in the handles to also pass through the back panel 308 and couple with corresponding threads in the portable display 300.

The back panel 308, the front panel 306, or both, can couple with the box 304 using one or more screws. The screws can be any appropriate type of screws, e.g., 8-32 flathead or Philips head screws.

The back panel 308 can include one or more brackets 312a-b to couple with a pole, e.g., the pole 212. By coupling with the pole, the brackets 312a-b can enable the frame 302, and any coupled portable display 300, to be supported by a base attached to the pole, e.g., as described with reference to FIGS. 2A-B.

The front panel 306 includes an aperture 310. The aperture 310 minimizes an amount of the front of the display 300 that the front panel 306 covers, e.g., while enabling the front panel 306 to connect with the front surface of the portable display 300. For instance, the aperture 310 enables the front panel 306 to connect with the front surface of the portable display while not blocking access to a display screen, e.g., the display screen 202.

As shown in FIG. 3C, the front panel 306 can have a uniform surface or can include any appropriate types of designs, such as logos or other images. For instance, a top portion 314 of the front surface of the front panel 306, opposite a surface closest to the portable display 300, can include a logo for the venue at which the portable display 300 is used. A bottom portion 316 of the front surface can include a logo for the host system. Either or both logos can be positioned on different portions of the front surface or the frame 302.

At least one of the logos can depict an animal 318. The animal 318 can include eyes that change appearance, e.g., while the portable display 300 displays a presentation. The change in appearance can be movement of the eyes, e.g., blinking of the eyes, lateral movement of the eyes, or a combination of both. In some examples, the eyes can glow. The appearance of the glow can change, e.g., in intensity, color, or both.

The frame 302 can be manufactured from any appropriate type of material. For instance, the frame 302 can be made from acrylic or other plastic material.

In some implementations, the frame 302 can include one or more configurable elements. The configurable elements can be elements that open, close, turn on, turn off, or a combination of these. One example of an element that can open and close is a shutter. The configurable elements can perform at least some of these operations automatically, e.g., in response to the frame receiving one or more instructions from the host system. The configurable elements can perform at least some of these operations in response to receipt of user input. For instance, a light configurable element can turn off or on in response to positioning of a mechanical switch, selection of a user interface element presented on a user interface, e.g., displayed on an administrative device, or a combination of both.

The one or more configurable elements can be configured to operate in parallel with display of a presentation on the portable display 300. For instance, the host system, described above with reference to FIG. 1, can determine a time for initiation of a configurable element. The time can be any appropriate type, e.g., such as a time standard time or a time given a reference point. The reference point can be initiation of the display of the presentation. In this way, the host system can optimize presentation of content by a configurable element during display of the presentation, e.g., of the personalized message.

The frame 302 can include an aperture or another component to which a corresponding configurable element, e.g., shutter, couples. For instance, the frame 302 can include two apertures in the top surface of the frame 302, e.g., in the box 304, into which corresponding lights, lasers, or sparklers are mounted. The frame 302 can include an aperture on its back panel 308 for a smoke dispenser. The frame 302 can include an aperture on its bottom surface or top surface, e.g., in the box 304, into which a confetti dispenser is mounted.

In some examples, the frame 302 is a separate device from the display 300. One or more of the components of the frame can be optional.

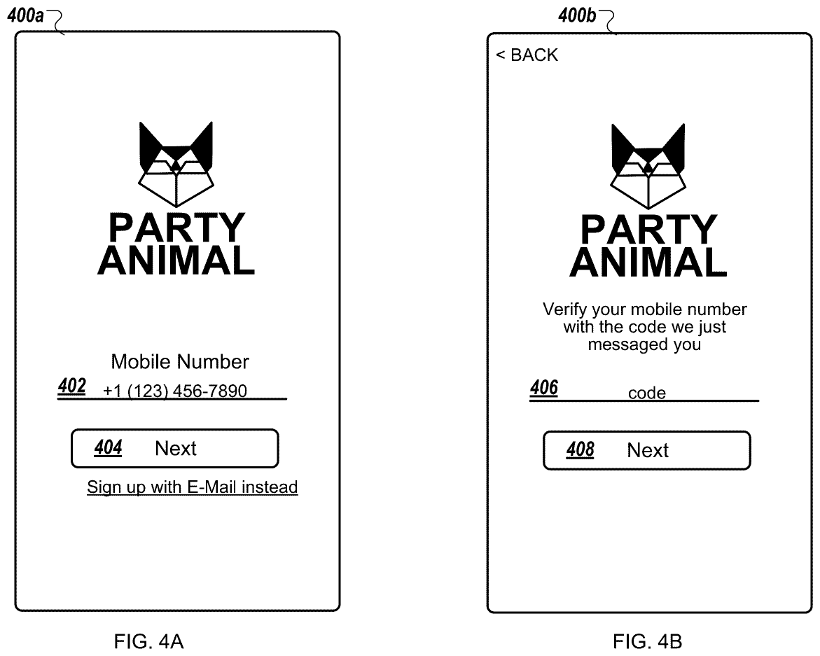

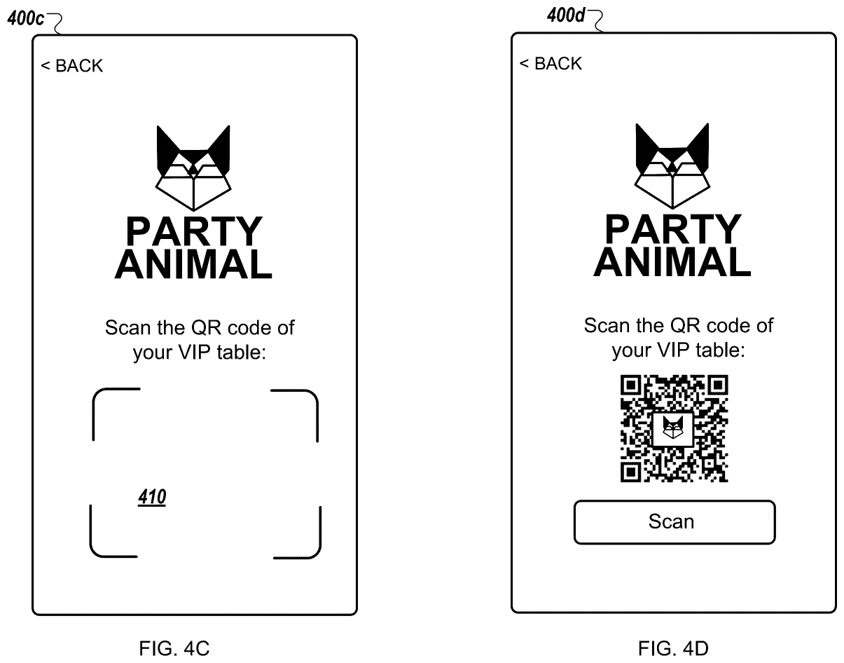

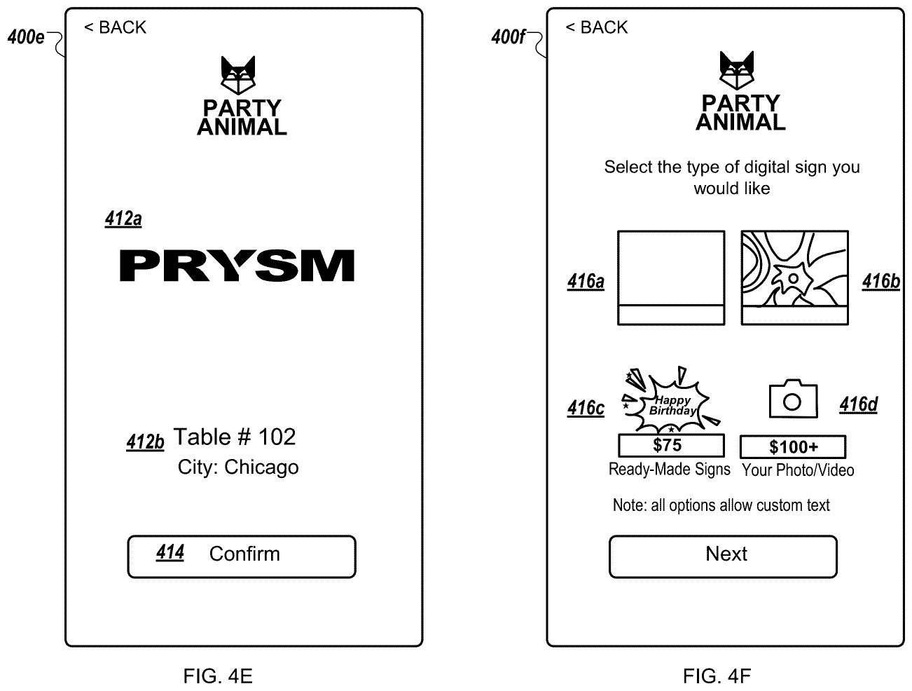

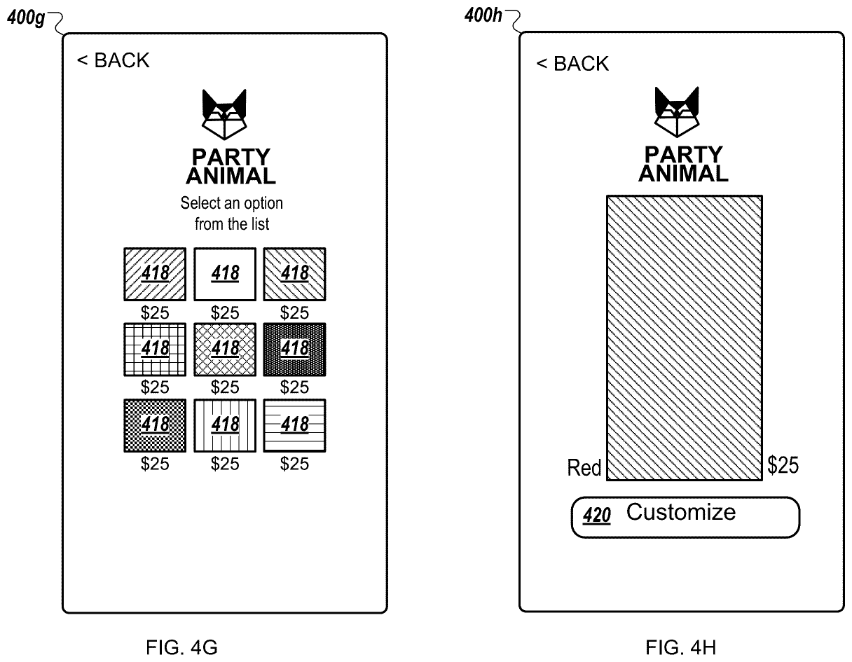

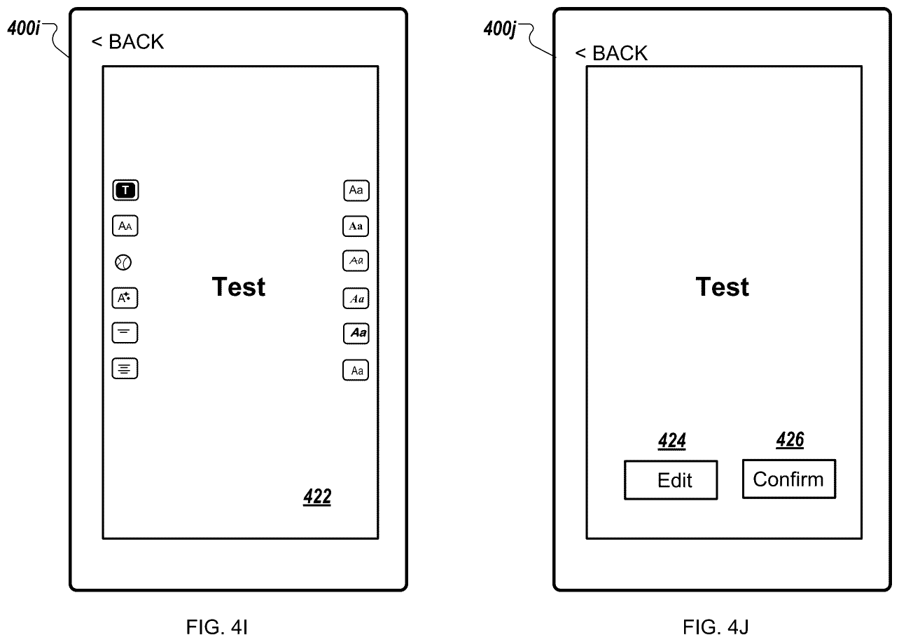

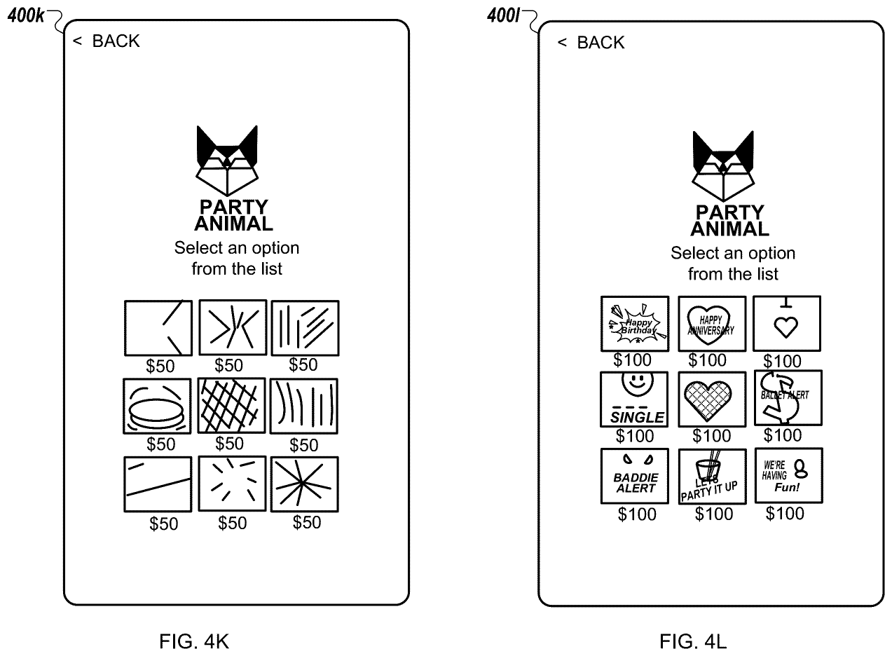

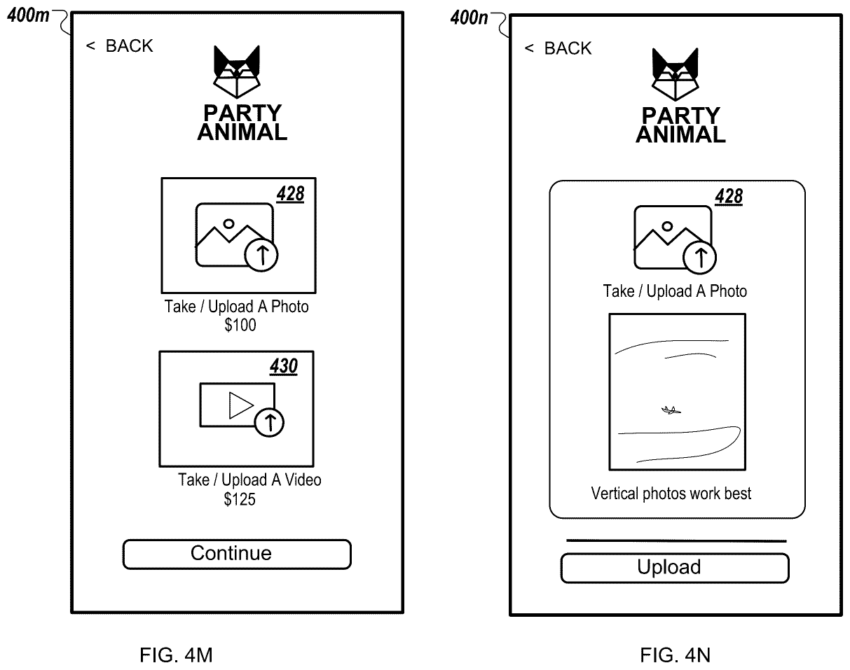

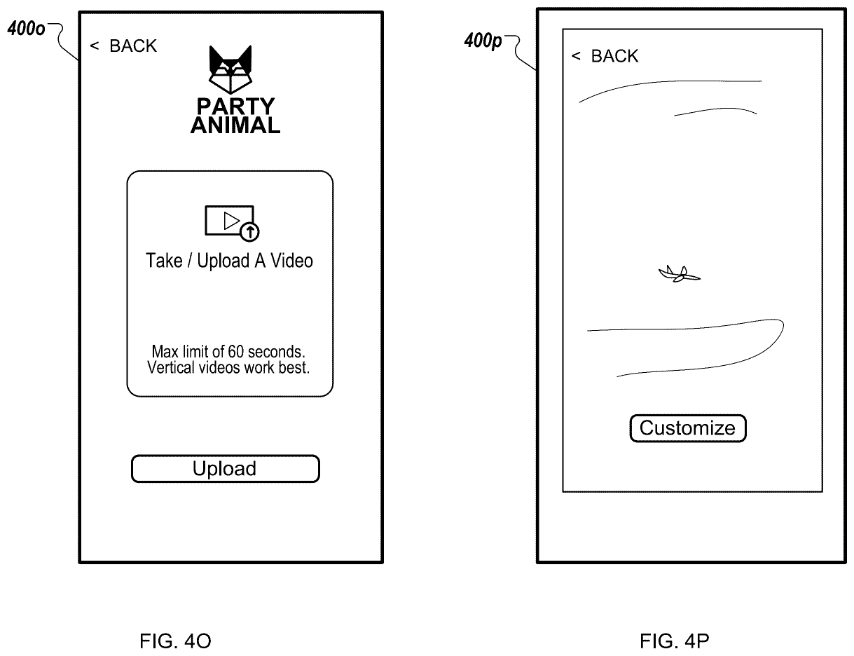

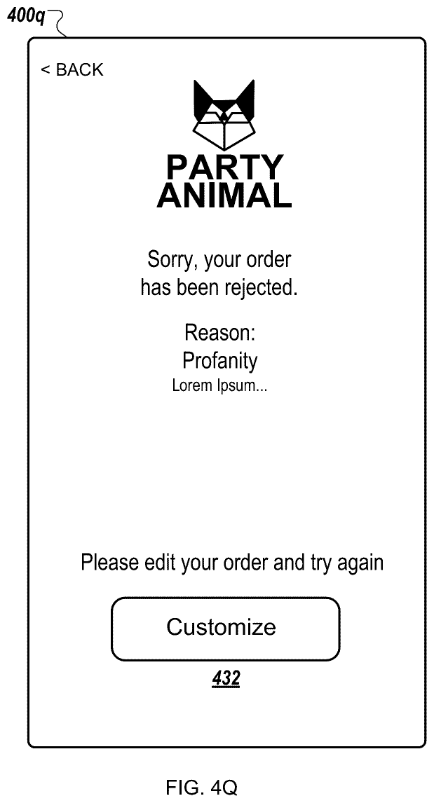

FIGS. 4A-Q are example user interfaces 400a-q that depict user interface elements for an end user flow on a requesting mobile device. The device can present the user interfaces 400a-q via a dedicated application or via a web application, for example. Although the examples in FIGS. 4A-Q are described with reference to a mobile application, similar user interfaces can be provided for other types of devices. The requesting mobile device can access the application by entering the appropriate URL (e.g., via a QR code or manually).

The user interfaces 400a-q are generally described as being displayed as part of a process, with an earlier user interface displayed before a latter user interface. For instance, selection of a user interface element on an earlier user interface can cause presentation of the subsequent user interface, e.g., 400a can lead to 400b. In some examples, selection of a user interface element can cause presentation of a non-sequential user interface, e.g., 400e can lead to 400a.

FIG. 4A depicts an example user interface 400a that initiates a requesting device login process with the host system. The user interface 400a includes an identifier entry field 402. The identifier can include any appropriate identifier, such as a phone number, an email address, a username, or other appropriate contact information. When the requesting device detects selection of a next interface element 404, the requesting device can send data for the identifier to the host system.

The requesting device can then display the example user interface 400b that requests input for a verification code. The user interface 400b includes a code entry field 406. Upon entry of a code in the code entry field 406, and selection of a next interface element 408, the requesting device can send data for the code to the host system. The host system can confirm that the received code and the code transmitted to the requesting device, e.g., via a phone number or email address, are correct. In implementations in which the identifier is a username, the host system can determine a phone number or an email address for the username using corresponding account information.

The requesting device can display the user interface 400a after scanning a QR code, after entry of a uniform resource identifier (“URI”), after launching an application, or in response to other appropriate input.

The requesting device can display an interface that includes a location entry interface element, e.g., that prompts for location information. The location entry interface element can be a text entry field, e.g., for alphanumeric characters. In some examples, the interface can be the example user interface 400c shown in FIG. 4C that prompts for a scanning of a QR code. The user interface 400c can include a scan field 410 that depicts content currently captured by a camera included in the requesting device.

In some examples, the requesting device can display a user interface 400d, shown in FIG. 4D, that prompts scanning of a QR code. The user interface 400d can include instructions on where to find a QR code or other location information.

The requesting device can analyze the QR code or other entered location information and present a confirmation user interface 400e, shown in FIG. 4E. The confirmation user interface 400e includes one or more fields 412a-b that display the determined location information, e.g., a venue name, table information, and city. The location information can indicate an area of the venue at which the requesting device is physically located, e.g., given the scanning of the QR code at a table at the venue by the requesting device.

The confirmation user interface 400e includes a confirmation user interface element 414. Selection of the confirmation user interface element 414 triggers the requesting device sending the location information to the host system, storing the location information in memory, e.g., for use in a presentation request, or a combination of both. By sending the location information to the host system, the host system can determine that a presentation request might be received for the corresponding location. The host system can use the location information to provide assistance for the requesting device. The host system can use the location information when selecting portable displays for other presentation requests, e.g., predicting that a request will be received for the corresponding location. This can reduce a likelihood that a portable display will not be available for the corresponding location.

In some implementations, when the requesting device initially captures an image depicting a QR code, e.g., with a camera application, in response, the requesting device can present the confirmation user interface 400e. The requesting device can then display the user interfaces 400a-b of FIGS. 4A-B to verify information for the requesting device. These implementations might not present the user interfaces 400c-d. After verifying information for the requesting device using the user interfaces 400a-b, the requesting device can display the user interface 400f.

The user interfaces 400f-p depict various interface elements for selecting different options for a personalized message. Other types of presentations can have similar interfaces for customization of the corresponding presentation. For example, the requesting device can display, in an image type user interface 400f shown in FIG. 4F, user interface elements 416a-d that trigger selection of different image types. The images can be used for a background of the presentation, e.g., the personalized message, or other content displayed with the presentation. Selection of various ones of the user interface elements 416a-d can cause presentation of corresponding selection user interfaces 400g, 400k-m that are shown in FIGS. 4G, 4K-M.

The images, e.g., backgrounds, can be static or dynamic (e.g., videos or moving patterns). For instance, selection of an image in a sequence of images can be selection of a video. The image selected can be a representative image of the sequence, e.g., a first image or an image that otherwise represents the sequence.

FIG. 4G depicts a color selection user interface 400g, e.g., which display can be triggered in response to detecting selection of the color user interface element 416a. The color selection user interface 400g depicts multiple color selection interface elements 418. Selection of a corresponding interface element 418 can indicate selection of the corresponding color as the background of the presentation.

FIGS. 4H-J depict example user interfaces 400h-j for customization of a presentation, e.g., the personalized message. For instance, FIG. 4H depicts a larger image of the selected background color in the user interface 400h. The user interface 400h includes a customize interface element 420 that triggers customization of the personalized message.

FIG. 4I depicts an example user interface 400i with multiple personalized message customization interface elements. The personalized message customization interface elements can include options to customize the message foreground, e.g., the text of the message and one or more font options, such as font type, font size, and font emphasis, to name a few examples. The personalized message customization interface elements can include options to add another image, change font alignment, add different messages in different locations of the user interface 400i, or a combination of two or more of these.

Selection of a trigger interface element 422 can cause display of a preview user interface 400j, shown in FIG. 4J. The preview user interface 400j can display the presentation as it would appear on the portable display, e.g., but at a smaller scale. The preview user interface 400j includes an edit interface element 424. Selection of the edit interface element 424 can trigger presentation of the user interface 400i that enables changes to the presentation.

The preview user interface 400j includes a confirmation interface element 426. Selection of the confirmation interface element 426 can trigger the requesting device to send a corresponding presentation request, e.g., personalized message request, to the host system, prompt for payment information, perform another appropriate action for the presentation request, or a combination of two or more of these.

The user interfaces 400i-h can be presented for any of the image types, e.g., in response to selection of a corresponding interface element for the user interfaces 400k-m shown in FIGS. 4K-M.

FIGS. 4K-L depict user interfaces 400k-l for selection of a graphic or a ready-made sign, respectively. The requesting device can display the user interface 400k-l in response to detecting selection of a corresponding one of the user interface elements 416b-c, respectively.

FIGS. 4M-P depict user interfaces 400m-p for an image upload process. The user interface 400m can include separate upload interface elements for a photo 428 or a video 430. Selection of the corresponding interface element 428, 430 can cause display of the user interfaces 400n-o shown in FIGS. 4N-O, respectively.

One or more of the user interfaces 400m-o can indicate a preferred image layout. For instance, the user interfaces 400n-o can indicate that portrait, e.g., vertical, photos work best for presentation on the portable display.

FIG. 4P depicts a user interface 400p for previewing an uploaded image or video, e.g., similar to the user interface 400h.

In some implementations, the requesting device can, after message selection (e.g., background selection and foreground customization) and submission, display one or more user interfaces that prompt for payment information, confirm receipt of payment, or both. When the requesting device received account information, the requesting device might use the account information to facilitate payment without prompting for payment information.

FIG. 4Q depicts an example presentation rejection user interface 400q. As described below, the selected presentation can be rejected by an administrative account, e.g., if the presentation contains profanity or other offensive content. Upon rejection, the requesting device displays the presentation rejection user interface 400q that indicate the rejection. The presentation rejection user interface can include an interface element 432 that triggers customization of a previously submitted presentation request, e.g., to remove the offensive content. The requesting device can communicate with the host system to retrieve data for the presentation request, e.g., when the requesting device is not able to access the data for the presentation request locally. In some examples, rejection can occur before the requesting device displays any payment information user interfaces.

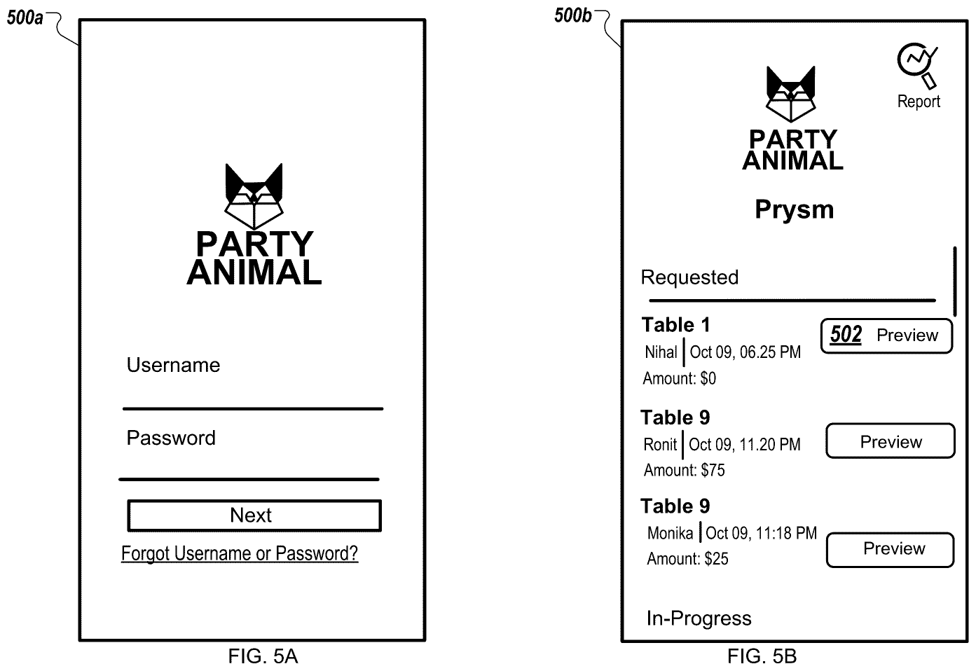

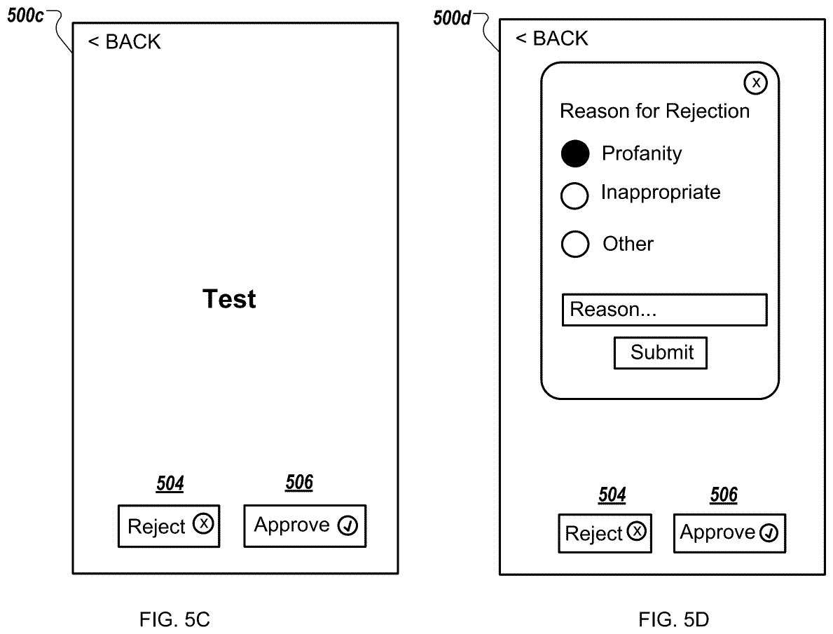

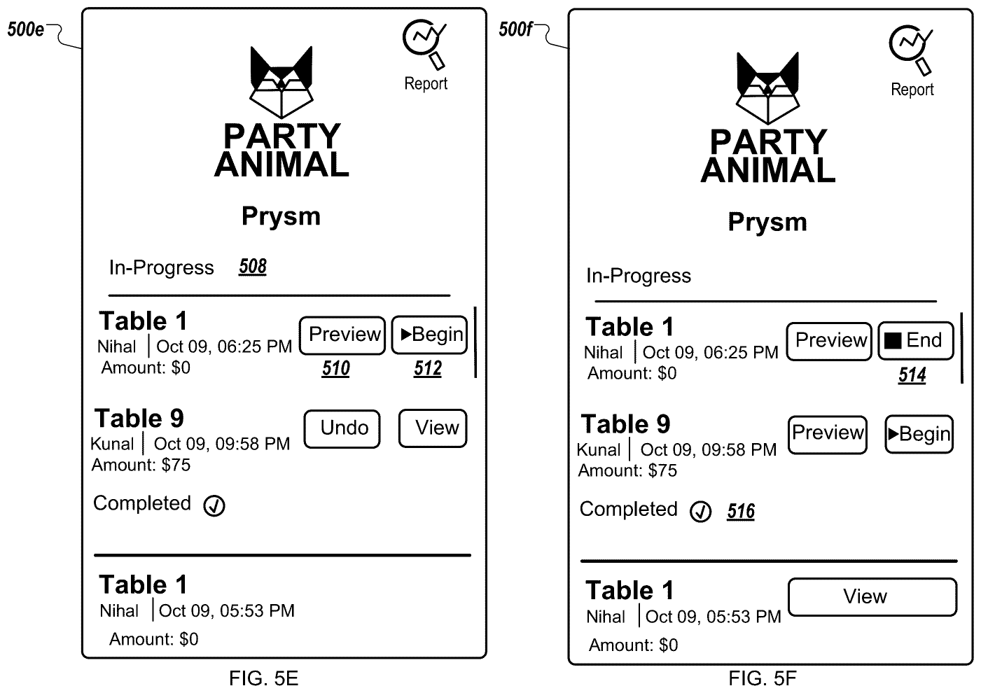

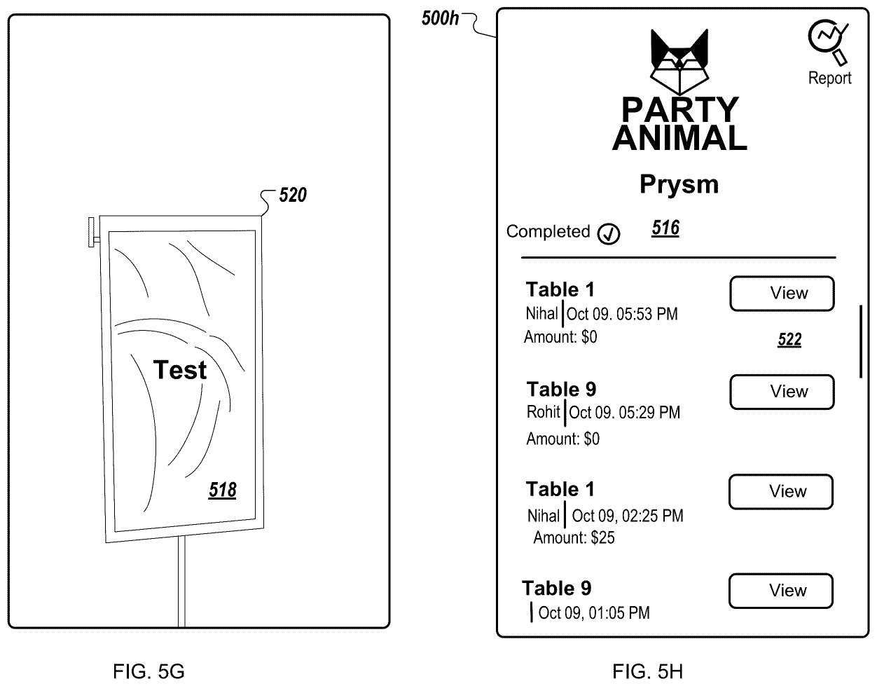

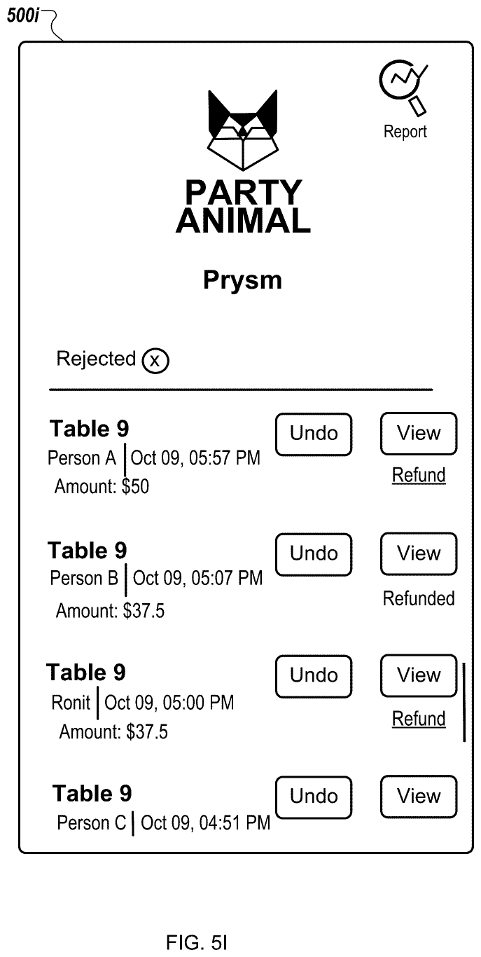

FIGS. 5A-5I are example user interfaces 500a-f and 500h-i for a venue and an example presentation display 518 by a portable display. The login user interface 500a, shown in FIG. 5A, includes a login interface with a password to limit access. An administrative device can depict the login user interface 500a, e.g., irrespective of the type of administrative account.

The requested presentations user interface 500b, shown in FIG. 5B, displays message order requests from requesting devices in a list. The requested presentations user interface 500b can include one or more user interface elements 502 that trigger display of a preview of the corresponding presentation. The requested presentations user interface can depict information about the corresponding presentation, e.g., a presentation location, a request receipt time, and information about a person associated with a request, to name a few examples. The list can display the most recently received presentation request at the top of the list. In some examples, the list can display the most recently received presentation request at the bottom of the list.

In some examples, only devices for administrative accounts with the most access, e.g., manager accounts, display the requested presentations user interface 500b and the related user interfaces 500c-d.

Upon selection of a preview interface element 502, the device displays a preview of the corresponding presentation, as shown in the preview user interface 500c of FIG. 5C. The user interface 500c includes user interface elements for rejecting 504 and approving 506 the presentation request. Selection of the corresponding interface element can cause the host system, e.g., upon receipt of a corresponding message from the device, to update a record for the presentation request in a database. Selection of the reject interface element 504 can cause presentation of the user interface 500d, shown in FIG. 5D. The user interface 500d includes a list of reasons for rejection, with an option to enter a custom reason. In response to submission of a rejection, the device sends the corresponding message to the host system. The host system then sends a rejection message to the corresponding requesting device that includes any explanation for the rejection, e.g., as shown in FIG. 4Q, described above.

When the presentation request is approved, the host system can add the request to an “in progress” queue, or another appropriate queue. An administrative device can request, from the host system, information about the in progress requests. In response, the administrative device can receive instructions that cause presentation of a user interface 500e that includes an in progress request list 508. The user interface 500e can be part of the user interface 500b shown in FIG. 5B, e.g., for administrative devices that have the appropriate permissions to access the corresponding data such as approve requested presentations.

The in progress request list 508 depicts information about multiple presentation requests such as a location for the corresponding presentation, a preview interface element 510, and a start presentation interface element 512. Selection of the preview interface element 510 can cause presentation of the preview user interface 500c of FIG. 5C. Selection of the start presentation interface element 512 can trigger the interface element to become a stop presentation interface element 514, depicted in the user interface 500f shown in FIG. 5F.

Selection of the start presentation interface element 512 can trigger display of the presentation 518 on a portable display 520, as shown in FIG. 5G. The presentation 518 corresponds to the preview shown in FIG. 5C.

Before, during, or after triggering display of the presentation, the portable display can be brought to the area at which the requesting device is located. For instance, as the portable display is moved from a back room to a venue area with people, e.g., patrons, the host system can receive a message from an administrative device triggering display of the presentation. The host system can then send an instruction to the portable display to trigger initiation of the presentation. For instance, a person or a robot can use the handles on the portable display to remove the portable display from the stand and carry the portable display to the area at which the requesting device is located, or another area identified in the presentation request, e.g., when those areas are different areas.

Returning to FIG. 5F, while the presentation is displayed on the portable display, the user interface 500f includes the stop presentation interface element 514. When display of the presentation stops, the user interface can depict the start presentation interface element 512. The presentation can stop at the end of a video sequence, when the host system receives data indicating selection of the stop presentation interface element 514, or at another appropriate time. In some examples, when the video sequence ends, the portable display can present the first image, the last image, or another representative image for the video sequence. In this way, the portable device can continue to display content for the presentation until a later time, e.g., until the host system receives the data indicating selection of the stop presentation interface element 514.

In some implementations, display of the presentation can begin in response to other appropriate input. For instance, the display can have an interface element that triggers initiation of the presentation. The interface element can be a hard button, a soft button, or another appropriate type of interface element.

In some examples, the user interface 500f includes a completed presentation list 516. The completed presentation list 516, as shown in more detail in FIG. 5H, includes information about presentations that have stopped. The host system can change a status of a presentation, e.g., move the queue in which the presentation is assigned, after display of the presentation ends, whether the presentation was presented in whole or in part.

The completed presentation list 516 can include a view user interface element 522 that triggers a preview of the presentation, e.g., as shown in FIG. 5C.

FIG. 5I depicts an example rejected presentation user interface 500i. Upon rejection of a presentation request, as described above with reference to FIGS. 5C-D, the host system can change a status of a presentation to rejected, move data for the presentation to a rejected queue, or a combination of both. An administrative device will full permissions, e.g., operated by a manager, can access the rejected presentation user interface 500i that includes information about the rejected presentations, e.g., and is generated using data for the corresponding rejected status of the presentations.

The rejected presentation user interface 500i includes an undo rejection interface element 524 that triggers the host system to change the status of the corresponding presentation. The status can be changed to requested, in progress, or another appropriate status.

A view presentation interface element 526 can trigger display of a preview of the presentation, e.g., as shown in FIG. 5C.

The presentations displayed in the various lists can be presented in any appropriate order. For instance, the presentations can be displayed based on the order in which they were approved, completed, requested, or some combination of these. The order can be chronological or reverse chronological.

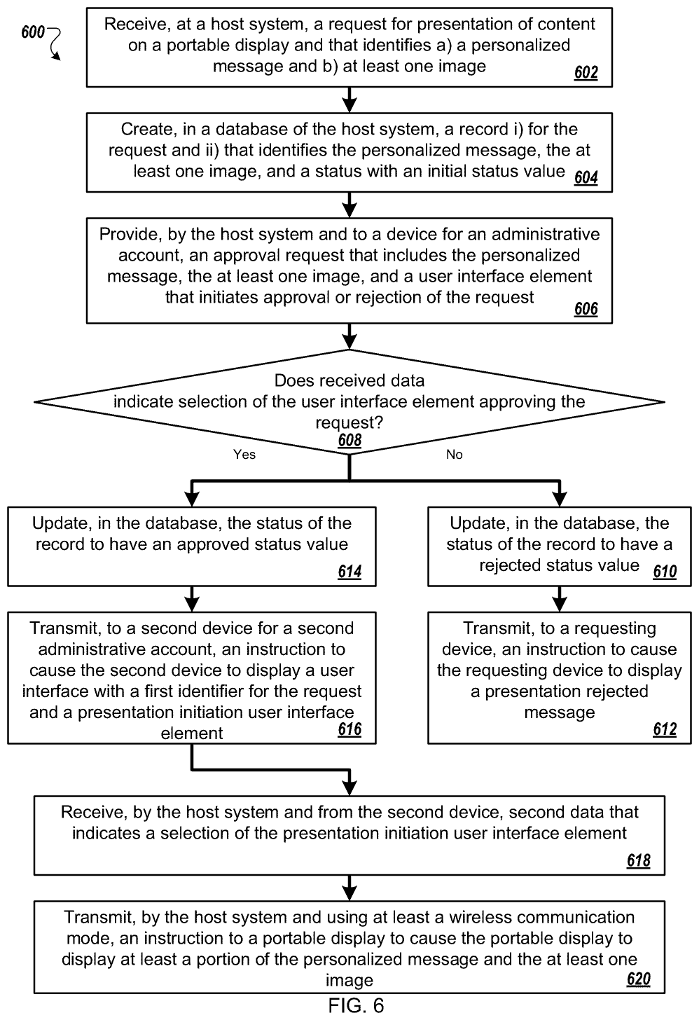

FIG. 6 is a flow diagram of an example process 600 for transmitting an instruction to a portable display. For example, the process 600 can be used by the host system 102 from the environment 100, e.g., to control the portable display 104.

A host system receives a request for presentation of content on a portable display and that identifies a) a personalized message and b) at least one image (602). The host system receives the request from a requesting device. The request can be for any appropriate presentation type and need not necessarily be for a personalized message.

The host system creates, in a database of the host system, a record i) for the request and ii) that identifies the personalized message, the at least one image, and a status with an initial status value (604). In implementations that include multiple presentation types, the record identifies the presentation type, e.g., whether or not it is a personalized message.

The host system provides, to a device for an administrative account, an approval request that includes the personalized message, the at least one image, and a user interface element that initiates approval or rejection of the request (604). The approval request can include other content from the presentation request, e.g., any customizable or customized content. For instance, for other presentation types, the approval request can include any customized messages, uploaded images, uploaded audio signals, e.g., whether uploaded by a requesting device or another system or device, or a combination of these.

The host system determines whether received data indicates selection of the user interface element approving the request (608). For instance, in response to receipt of the approval request, the device can present a user interface that includes a user interface element. Selection of the user interface element can trigger approval or rejection of the presentation request, e.g., depending on how the user interface element is configured, the type of selection, or both. In response to receipt of input indicating selection of the user interface element, the device can transmit the data that indicates the selection to the host system. The host system can determine whether the data indicates approval or rejection of the presentation request.

The host system updates, in the database, the status of the record to have a rejected status value (610). For example, in response to determines that the received data indicates selection of the user interface element not approving, e.g., rejecting, the request, the host system updates the status of the record to include a rejected status value.

The host system transmits, to a requesting device, an instruction to cause the requesting device to display a presentation rejected message (612). Display of the presentation rejection message can include display of one or more user interface elements that trigger modifications to the rejected presentation request, and resubmission of a modified presentation request.

The host system updates, in the database, the status of the record to have an approved status value (614). For instance, in response to determining that the received data indicates selection of the user interface element approving the request, the host system updates the status to the approved status value. When creating the record, the status type can have a value of requested or another appropriate value. As a result, when the host system receives the presentation approved data, the host system can change the status from the requested value to the approved value.

The host system transmits, to a second device for a second administrative account, an instruction to cause the second device to display a user interface with a first identifier for the request and a presentation initiation user interface element (616). For example, the host system causes the second device to display a menu that includes a user interface element that triggers display of the presentation on the portable display.

The second administrative account can have any appropriate type of relationship with the first administrative account. For instance, the two accounts can be the same account. In these examples, the device and the second device can be the same device. In some examples, the administrative account and the second administrative account have different account permissions. For example, the administrative account can approve presentation requests while the second administrative account cannot. The second administrative account, and optionally the administrative account, can trigger display of the presentation, e.g., can have corresponding devices display the presentation initiation user interface element.

The host system receives, from the second device, second data that indicates a selection of the presentation initiation user interface element (618). For example, after display of the presentation initiation user interface element, the second device can detect input that selects the presentation initiation user interface element. In response, the second device can transmit the second data to the host system.

The host system transmits, using at least a wireless communication mode, an instruction to a portable display to cause the portable display to display at least a portion of the personalized message and the at least one image (620). The host system can transmit the instruction in response to receipt of the second data from the second device. The host system can use any appropriate type of wireless communication mode to communicate with the portable display. For instance, the host system can use a direct wireless connection with the portable display, a wireless network that connects to at least the portable display, one or more other networks that connect the host system to the wireless network, or a combination of these.

In some implementations, when the host system can cause multiple portable displays to display the personalized message or content for another presentation type, the host system can select, from a plurality of portable displays and using an identifier for the record that was included in the request, the portable display. The selection using the record identifier can include using any appropriate data from the record. For instance, the host system can use a physical location for the requesting device that is indicated in the record. The physical location can be a location in a venue, e.g., table 5 or upper floor. For instance, the location need not include an exact location of the requesting device. The host system can select the portable display without using an identifier for the requesting device or an account for the requesting device.

The order of operations in the process 600 described above is illustrative only, and transmission of the instruction to the portable display can be performed in different orders. For example, the host system can transmit the instruction to the second device and then update the status of the record in the database. In some examples, the host system can transmit the instruction to the requesting device and then update the status of the record in the database.

In some implementations, the process 600 can include additional operations, fewer operations, or some of the operations can be divided into multiple operations. For example, the process 600 can include operations 602 through 608 and 614 through 620 without operations 610 and 612. The process 600 can include operations 602 through 608, 618, and 620 without the other operations. The process 600 can include operations 604, 614, 618, and 620 without the other operations.

In some examples, the host system can select multiple portable displays for display of a presentation. For instance, the host system can select, from a plurality of portable displays, two or more portable displays including the portable display. The host system can then transmit, using at least the wireless communication mode and to each of the two or more portable displays, a corresponding instruction to cause the corresponding portable display to display a respective portion of the personalized message. The instructions sent to the different portable displays can be the same instructions or different instructions. The instructions might be different when the portable displays have different brands, different models, different operating systems, different instruction sets, or a combination of these.

As mentioned above, the host system can process presentation requests for any of multiple different presentation types. Depending on the presentation type, the requesting device can be in different physical locations. For instance, for a personalized message, or personalized greeting, the requesting device can be at a venue. For a leader board, interactive experience, auction message, or branded experience, the requesting device can be at any appropriate physical location. For example, for these latter presentation types, the records created in the request database might not include location data while records created for the former types of presentation types might have location data.

In more detail, a branded experience can be a type of a personalized message defined by a particular entity. In contrast to a personalized message that has an intended recipient, e.g., at the area identified in the presentation request, a branded experience might not have physical location data. For instance, a branded experience can enable a brand or another entity to display a message, e.g., about their product or service. A system for the brand can transmit the presentation request to the host system. The presentation request can identify a message, one or more images, e.g., for products of the brand, or other appropriate content.

In some examples, when a presentation of another type has branded content, e.g., in a background or in a video (when the video is not already part of the background), the presentation can be a branded experience when the brand provides payment for at least part, if not all, of the presentation. For example, a branded experience can be a subtype of a leader board, a personalized message, a personalized greeting, an interactive experience, or an auction message.

A personalized greeting presentation can be a subtype of a personalized message. As part of the display of the personalized message, the host system can communicate with one or more other systems for presentation of an audio signal by another system during at least a portion of the display of the personalized message. The other system that presents the audio signal can present an audio signal encoding the speech of a person, e.g., a disc jockey (“DJ”), a musician, an influencer, or another appropriate type of person such as another type of celebrity.

The other system, e.g., part of a stereo system at the venue, can present live, recorded, or a combination of both, audio. For instance, the other system can present a live callout from a DJ, playback of a particular song, or both, during the display of the personalized message. The other system can present a pre-recorded message from friends unable to attend the event during which the personalized message is displayed. The other system can present a live presentation by a musician, e.g., for a person's favorite type of music identified in the presentation request.

In some examples, the other system can be a streaming system that streams content from a remote location. For instance, if the person providing the message is not at the venue, the host system can connect with the other system to provide a live audio stream or audio and video stream of the person during the display of the personalized message.

When the audio signal encodes pre-recorded content, the content can be specific to the personalized message, template content, or a combination of both. For instance, when the host system receives the presentation request at least a threshold time period before display of the personalized message, the host system can facilitate recording of the content. This can include selecting an artist from a list of multiple artists, e.g., whom satisfy one or more requirements for the presentation request such as being able to play a particular musical instrument. The host system can provide a device of the artist with particular phrases to say, a song to play, general information about the type of event for the personalized message, or other appropriate content. The host system can receive the pre-recorded content from the device and present the pre-recorded content using the venue's stereo system.

In implementations for which a personalized message requests a live performance, e.g., by a local artist, the host system can facilitate presentation of the live performance. For instance, the presentation request can identify a live performance type, e.g., a type of musician, a type of music, or another appropriate live performance type. The host system can access a database of artists for the live performance type and facilitate presentation of the live performance during the display of the personalized message.

For a leader board presentation type, the portable display can display information for a leader board for the venue. The leader board can be any appropriate type of leader board, such as information about who is winning a game, e.g., darts, or another appropriate activity type.

The leader board presentation on the portable display can include social aspects, e.g., specific to the activity type.

In some implementations, the leader board can be sponsored by a brand or another entity. When sponsored by an entity, content presented on the portable display can include some content for the entity, e.g., an advertisement or branding for the entity.

In some implementations, the portable display can be used for an interactive experience. An interactive experience can include presentation of a user interface on the portable display. The portable display can communicate, directly or indirectly, with multiple portable client devices, e.g., smartphones. The communication can cause presentation of an extension of the user interface on the portable client devices and enable the portable client devices to interact with content presented on the portable display.

For instance, the host system can provide, to the portable display, first instructions for presentation of a global user interface. The global user interface can include any appropriate content, e.g., user interface elements and other content, with which the multiple portable devices can interact. For instance, the global user interface can depict a primary interface for a pinball game. The host system can provide, to at least some of the multiple portable client devices, instructions for presentation of a local user interface. The local user interface can include user interface elements that might have different states on the different portable client devices that display the local user interface. As a portable client device receives input that indicates interaction with some of the various user interface elements, the corresponding local user interface for that portable client device changes state. For instance, as a portable client device receives input indicating selection of a virtual flapper, the input can trigger movement of the virtual flapper on the portable client device's local user interface while the global user interface, which does not include a user interface element for the virtual flapper, does not depict the changed state of the virtual flapper. In examples in which the global user interface depicts the virtual flapper, the input can trigger movement of the virtual flapper on the global user interface.

The local user interfaces for the other portable client devices can have any appropriate state. For instance, as a first local user interface changes a state of a user interface element in response to input, the local user interfaces for the other portable devices can have a similar state change for the user interface element, e.g., showing the change caused by the first portable client device presenting the first local user interface. In some examples, the other portable devices do not have a similar state change caused by the input received by the first portable client device.

As the portable display moves throughout a venue, the host system or another component of the environment, can enable a different portable client device to control interaction with the global user interface. For instance, the component can enable a closest portable client device, e.g., that is presenting the local user interface, to the portable display to control interaction with the global user interface.

In some examples, multiple portable client devices can interact with the global user interface at the same time. For example, depending on the content presented on the global user interface, the global user interface can enable state changes to the global user interface by multiple portable client devices. This can occur when a pinball game depicts multiple balls controlled by different portable client devices, to name one example. In these examples, the host system or another component of the environment can select the portable client devices that interact with the global user interface.

As mentioned above, the interactive experience can be promoted by a brand or another entity. As a result, the content presented in the global user interface, a local user interface, or a combination of both, can include brand specified information, e.g., a logo or other content selected by the brand.

The interactive experience, or another one of the different presentation types, can be selected from multiple predetermined interactive experiences stored in a database, e.g., in the template database. The database can include different types of interactive experiences, e.g., different types of games. For the different types of interactive experiences, the database can include different types of user interface elements. For example, a first interactive experience can have two themes—a cartoon theme and a serious theme. The database can maintain, in memory, different types of user interface elements for each of the themes. For a pinball game, the database can maintain cartoon flappers for the cartoon theme and blocky flappers for the serious theme. As a result, a presentation request can specify an element type for the interactive experience, or another presentation type. The element type can be specific to the presentation request, e.g., and all user interface elements for the presentation, or identify different types for different user interface elements.

The interactive experience, or another presentation type, can have a request size. The request size can indicate a quantity of elements for the presentation. The quantity of elements can be a number of local user interfaces for the interactive experience, e.g., a maximum or minimum required number of local user interfaces. The quantity of elements can be a number of controllable user interface elements for the presentation. For instance, the quantity of elements can specify a number of flappers for a pinball game, or a number of paddles for a virtual pong game.

The venue for the presentation can be any appropriate type of venue. For instance, the venue can be a restaurant, a bar, a night club, a stadium, e.g., for a sporting event, a shop, a festival, or an auction house. In the latter example, the portable display can present information about a product that is being bid on. The host system can receive, from a requesting device, a request for a presentation to present the information about the product. The host system can then cause the portable display to present the information, e.g., as the portable display is moved throughout the corresponding venue.

In this specification, the term “database” is used broadly to refer to any collection of data: the data does not need to be structured in any particular way, or structured at all, and it can be stored on storage devices in one or more locations. A database can be implemented on any appropriate type of memory.

In this specification, the term “engine” or “software engine” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

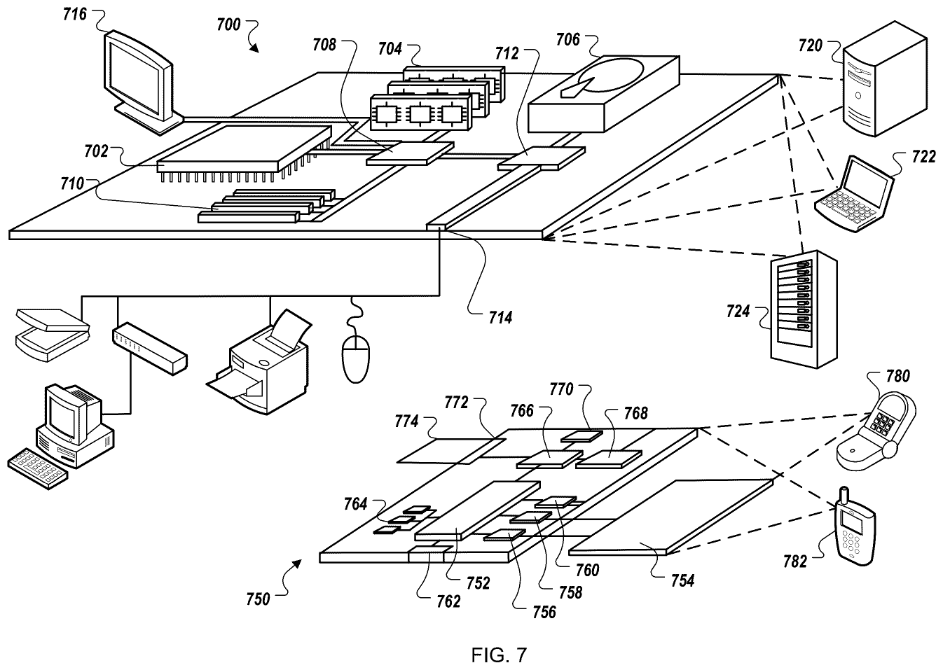

FIG. 7 is a block diagram of computing devices 700, 750 that may be used to implement the systems and methods described in this specification, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this specification.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

Accordingly, other examples are in the following claims.

What is claims is:

1. A method comprising:
receiving, at a host system, a request for presentation of content on a portable electronic display and that identifies a) a personalized message and b) at least one image;
creating, in a database of the host system, a record i) for the request and ii) that identifies the personalized message, the at least one image, and a status with an initial status value;
providing, by the host system and to a device for an administrative account, an approval request that includes the personalized message, the at least one image, and a user interface element that initiates approval or rejection of the request;
receiving, by the host system and from the device, data that indicates a selection of the user interface element approving or rejecting the request; and
in response to determining that the data indicates the selection of the user interface element approval the request:
updating, in the database, the status of the record to have an approved status value; and
transmitting, by the host system and using at least a wireless communication mode, an instruction to a portable electronic display to cause the portable electronic display to display at least a portion of the personalized message and the at least one image.

2. The method of claim 1, comprising:
in response to updating the status of the record to have the approved status value, transmitting, to a second device for a second administrative account, an instruction to cause the second device to display a user interface with a first identifier for the request and a presentation initiation user interface element;
receiving, by the host system and from the second device, second data that indicates a selection of the presentation initiation user interface element, wherein:
transmitting, by the host system and using at least the wireless communication mode, the instruction to the portable electronic display to cause the portable electronic display to display at least the portion of the personalized message and the at least one image is responsive to receiving the second data that indicates a selection of the presentation initiation user interface element.

3. The method of claim 2, wherein the administrative account and the second administrative account have different account permissions.

4. The method of claim 1, comprising selecting, from a plurality of portable electronic displays and using an identifier for the record that was included in the request, the portable electronic display.

5. The method of claim 4, wherein:
receiving the request comprises receiving, by the host system and from a requesting device, the request; and
selecting the portable electronic display from the plurality of portable electronic displays uses a physical location for the requesting device that is indicated in the record.

6. The method of claim 5, wherein selecting the portable electronic display without using an identifier for the requesting device or an account for the requesting device.

7. The method of claim 1, comprising selecting, from a plurality of portable electronic displays, two or more portable electronic displays including the portable electronic display, wherein:
transmitting the instruction comprises transmitting, by the host system and using at least a wireless network and to each of the two or more portable electronic displays, a corresponding instruction to cause the corresponding portable electronic display to display a respective portion of the personalized message.

8. The method of claim 1, wherein:
receiving the request comprises receiving the request that indicates a font size, a font color, and one or more font effects for the personalized message; and
creating the record comprises creating the record that includes, in corresponding fields for the record, data identifying the font size, the font color, and the one or more font effects.

9. The method of claim 1, wherein the at least one image comprises a video sequence.

10. The method of claim 1, wherein the at least one image comprises a dynamic image.

11. The method of claim 1, wherein the request includes the at least one image.

12. The method of claim 1, wherein the request includes an identifier for the at least one image already stored on the host system.

13. A system comprising:
a portable electronic display for displaying a personalized message and that includes a first communication module; and
a host system that includes a second communication module that enables wireless communication with the first communication module of the portable electronic display and with one or more requesting mobile devices, and one or more processors and one or more storage devices on which are stored instructions that are operable, when executed by the one or more processors, to cause the one or more processors to perform operations comprising:
receiving a message request from one of the one or more requesting mobile devices,
presenting the message request for approval, and
upon approval and activation, sending, using the second communication module and to the first communication module, the personalized message to the portable electronic display for display.

14. The system of claim 13, wherein:
the portable electronic display comprises a light, separate from a screen included in the portable electronic display; and
sending the personalized message comprises sending instructions to cause the portable electronic display to activate the light.

15. The system of claim 13, wherein:
the portable electronic display comprises a smoke dispenser; and
sending the personalized message comprises sending instructions to cause the portable electronic display to activate the smoke dispenser.

16. The system of claim 13, wherein:
the portable electronic display comprises a confetti dispenser; and
sending the personalized message comprises sending instructions to cause the portable electronic display to activate the confetti dispenser.

17. The system of claim 13, wherein:
the portable electronic display comprises a laser; and
sending the personalized message comprises sending instructions to cause the portable electronic display to activate the laser.

18. The system of claim 13, wherein:
the portable electronic display comprises a sparkler; and
sending the personalized message comprises sending instructions to cause the portable electronic display to activate the sparkler.

19. The system of claim 13, wherein the portable electronic display comprises an aperture that receives at least one of a smoke dispenser or a confetti dispenser.

20. The system of claim 19, wherein:
the portable electronic display comprises a door that maintains the smoke or the confetti in the aperture; and
sending the personalized message comprises sending instructions to cause the portable electronic display to activate the door and disperse at least some of the smoke or the confetti.
